(19) United States
(12) Patent Application Publication
(10) Pub. No.: US 2012/0047234 A1
(43) Pub. Date: Feb. 23, 2012

(54) WEB PAGE BROWSING SYSTEM AND RELAY SERVER

(75) Inventor: Hajime TERAYOKO, Tokyo (JP)

(73) Assignee: FUJIFILM CORPORATION, Tokyo (JP)

(21) Appl. No.: 13/212,053

(22) Filed: Aug. 17, 2011

(30) Foreign Application Priority Data
Aug. 18, 2010 (JP) JP2010-183256

(51) Int. Cl. G06F 15/16

(52) U.S. Cl. 709/219

(57) ABSTRACT

This invention allows a mobile terminal to browse a Web page without destroying the design of the Web page and, in particular, browse and operate even a Web page incorporating a piece of rich content, even if the mobile terminal does not have the function of browsing a Web page for PCs. A relay server converts a Web page into image data intended to be browsed (an image) and provides the image data to a mobile terminal. The relay server extracts a rich content area and detects a change in an image in the rich content area, if a Web page incorporates a piece of rich content. When a change in the image is detected, the relay server converts the current Web page into image data intended to be browsed and transmits the image data to a mobile terminal to update the screen.

### BACKGROUND OF THE INVENTION

1. Field of the Invention

The present invention relates to a Web page browsing system and a relay server and, more particularly, to a technique for browsing a Web page for PCs on a mobile terminal, such as a mobile phone, which has a limited screen size and is limited in downloadable file size.

2. Description of the Related Art

Web pages have often been browsed on mobile phones in recent years. However, since production of Web pages for mobile phones as well as Web pages for personal computers (PCs) is troublesome and expensive, Web page producers tend to avoid producing Web pages for mobile phones. It is not uncommon that a Web page which a user desires to browse is not for mobile phones and that a Web page for mobile phones corresponding to the Web page is not prepared.

Possible methods for browsing a Web page for PCs on a mobile phone which is smaller in screen size and downloadable file size than PCs include the process of receiving content files in pieces and displaying the content files across a plurality of pages. In this case, a Web page browsed on a PC looks different from the Web page browsed on a mobile phone.

Although conversion of a Web page into a markup language for mobile phones is also conceivable, the method is likely to destroy the design of the Web page.

To cope with the problem, there is proposed a method for converting a Web page for PCs into an image and displaying the image on a client terminal. For example, in Japanese Patent Application Laid-Open No. 2004-220260, a Web page is produced from constituent elements of an HTML document (Hyper Text Markup Language) or the like of a Web page acquired by an image distribution server, the produced Web page is converted into image data such as a bit map, and the image data is transmitted to a client terminal. When a user clicks on a displayed character string or the like with a pointing device, the client terminal displaying the image data transmits the coordinate data of the position of the click and the URL (Uniform Resource Locator) of the Web page corresponding to the displayed image data to the image distribution server. The image distribution server checks whether there is any link pointer corresponding to the transmitted click position coordinates, on the basis of the constituent elements of the Web page. If there is a corresponding link pointer, the image distribution server accesses a Web server specified by an URL indicated by the link pointer.

The technique in Japanese Patent Application Laid-Open No. 2004-220260 allows even a client terminal without a Web browser to browse a Web page.

Web pages incorporating expressive content (rich content) including a moving image (e.g., a video image or an animation) have recently become common. Typical pieces of rich content include ones created through Adobe Flash from Adobe Systems Incorporated.

The invention disclosed in Japanese Patent Application Laid-Open No. 2004-220260 does not support a Web page including a piece of rich content. More specifically, since an image as a piece of rich content changes regardless of a request to browse a Web page from a client, even if a Web page acquired at the time of a Web page browse request is converted into an image (a still image) and is provided to a client, a piece of rich content of the Web page displayed by a Web browser is different from a piece of rich content on the client terminal viewed by a user. Note that the piece of rich content on the client terminal viewed by the user is actually a still image and that the user cannot recognize the still image as a piece of rich content. Features of rich content are weakened.

When an image as a piece of rich content displayed on a client terminal is clicked if images as pieces of rich content are linked to URLs, a Web server may access an URL irrelevant to the displayed image as the piece of rich content. In this case, a user cannot browse an intended Web page.

### SUMMARY OF THE INVENTION

The present invention has been made in consideration of the above-described circumstances, and has as its object to provide a Web page browsing system and a relay server capable of browsing a Web page without destroying the design of the Web page and, in particular, of browsing and operating even a Web page incorporating a piece of rich content in the same manner as in a PC, even if a mobile terminal does not have the function of browsing a Web page for PCs.

In order to achieve the object, the invention according to a first aspect of the present invention is a Web page browsing system which includes a mobile terminal capable of displaying an image and a relay server converting a Web page provided by a Web server into an image and providing the image to the mobile terminal and allows the mobile terminal to browse a Web page, wherein the relay server includes: an extraction device which determines whether a Web page for which a browse request has been made by the mobile terminal includes a piece of rich content upon receipt of the browse request for the Web page and, if the Web page includes a piece of rich content, extracts a rich content area where the piece of rich content is displayed; a detection device which detects a change in the piece of rich content in the extracted rich content area; an image conversion device which converts the Web page into image data intended to be browsed on the mobile terminal in response to the browse request, the image conversion device converting the Web page into the image data intended to be browsed for a screen update when the detection device detects a change in the piece of rich content in the rich content area; and an image data transmission device which transmits the image data intended to be browsed obtained by the image conversion device to the mobile terminal.

According to the invention of the first aspect, the relay server converts a Web page into an image and provides the image to the mobile terminal. The Web page can be directly browsed on the mobile terminal without destruction of the design of the Web page. The mobile terminal only needs the function of displaying an image and does not need the function of browsing a Web page for PCs. If a Web page incorporates a piece of rich content, the Web page browsing system detects a change in the piece of rich content and converts the Web page into image data intended to be browsed in response to the change. The screen of the mobile terminal can be updated in response to a change in a piece of rich content. With this configuration, the mobile terminal can browse and operate a Web page in the same manner as in PCs.

In a second aspect of the present invention, the detection device in the Web page browsing system according to the first aspect includes an image acquisition device which acquires an image in the rich content area at predetermined intervals, a variation detection device which compares an image acquired this time by the image acquisition device with an image acquired last time and detects a variation between the images, and a determination device which determines, on the basis of the detected variation, that the piece of rich content has changed.

In a third aspect of the present invention, the determination device in the Web page browsing system according to the second aspect determines that the piece of rich content has changed if the variation detected by the variation detection device exceeds a predetermined threshold value. For example, if the piece of rich content is a moving image, the Web page browsing system can determine the changeover point between scenes or the like and update the screen. If the piece of rich content is a series of still images displayed as a slide show, the Web page browsing system can determine the changeover point between each two adjacent ones of the still images and update the screen.

In a fourth aspect of the present invention, the determination device in the Web page browsing system according to the second aspect determines that the piece of rich content has changed when no change is detected for a predetermined period of time after the variation is detected by the variation detection device. If the piece of rich content is a moving image, the screen can be updated when the moving image is stopped.

In a fifth aspect of the present invention, the variation detection device in the Web page browsing system according to any one of the second to fourth aspects includes a reduction device which reduces the image acquired this time by the image acquisition device and the image acquired last time and a calculation device which calculates a correlation value between the reduced images as an evaluation value indicating the variation between the images. The reduction of the images allows a reduction in the time required for the calculation device to calculate the evaluation value.

In a sixth aspect of the present invention, the detection device in the Web page browsing system according to the first aspect includes an image acquisition device which acquires an image in the rich content area at predetermined intervals, a storage device which stores an image of the piece of rich content in the rich content area after a change, a coincidence detection device which compares the image acquired by the image acquisition device with the image stored in the storage device and detects the degree of coincidence between the images, and a determination device which determines that the piece of rich content has changed when the image in the rich content area is detected coinciding with the image stored in the storage device on the basis of the detected degree of coincidence. According to this configuration, the timing for a screen update can be set by setting the image to be stored in the storage device in advance.

The invention according to a seventh aspect of the present invention is a relay server which communicates with a mobile terminal capable of displaying an image, converts a Web page provided by a Web server into an image, and provides the image to the mobile terminal, including: an extraction device which determines whether a Web page for which a browse request has been made by the mobile terminal includes a piece of rich content upon receipt of the browse request for the Web page and, if the Web page includes a piece of rich content, extracts a rich content area where the piece of rich content is displayed; a detection device which detects a change in the piece of rich content in the extracted rich content area; an image conversion device which converts the Web page into image data intended to be browsed on the mobile terminal in response to the browse request, the image conversion device converting the Web page into the image data intended to be browsed for a screen update when the detection device detects a change in the piece of rich content in the rich content area; and an image data transmission device which transmits the image data intended to be browsed obtained by the image conversion device to the mobile terminal.

In an eighth aspect of the present invention, the detection device in the relay server according to the seventh aspect includes an image acquisition device which acquires an image in the rich content area at predetermined intervals, a variation detection device which compares an image acquired this time by the image acquisition device with an image acquired last time and detects a variation between the images, and a determination device which determines, on the basis of the detected variation, that the piece of rich content has changed.

In a ninth aspect of the present invention, the determination device in the relay server according to the eighth aspect determines that the piece of rich content has changed if the variation detected by the variation detection devices exceeds a predetermined threshold value.

In a tenth aspect of the present invention, the determination device in the relay server according to the eighth aspect determines that the piece of rich content has changed when no change is detected for a predetermined period of time after the variation is detected by the variation detection device.

In an eleventh aspect of the present invention, the variation detection device in the relay server according to any one of the eighth to tenth aspects includes an image reduction device which reduces the image acquired this time by the image acquisition device and the image acquired last time and a calculation device which calculates a correlation value between the reduced images as an evaluation value indicating the variation between the images.

In a twelfth aspect of the present invention, the detection device in the relay server according to the eighth aspect includes an image acquisition device which acquires an image in the rich content area at predetermined intervals, a storage device which stores an image of the piece of rich content in the rich content area after a change, a coincidence detection device which compares the image acquired by the image acquisition device with the image stored in the storage device and detects the degree of coincidence between the images, and a determination device which determines that the piece of rich content has changed when an image in the rich content area is detected coinciding with the image stored in the storage device, on the basis of the detected degree of coincidence.

According to the present invention, a mobile terminal can browse a Web page without destroying the design of the Web page and, in particular, can browse and operate even a Web page incorporating a piece of rich content in the same manner as in PCs, even if the mobile terminal does not have the function of browsing a Web page for PCs.

### BRIEF DESCRIPTION OF THE DRAWINGS

FIG. 1 is a view showing how a Web page for PCs is browsed on each of a display unit 2 of a PC 1 and a display unit 14 of a mobile terminal 10;

FIG. 2 is a diagram showing an example of the overall configuration of a Web page browsing system 100;

FIG. 3 is a flow chart showing the operation until a desired Web page is displayed on the display unit 14 of the mobile terminal 10;

FIG. 4 is a view for explaining generation of UI metadata;

FIG. 5 is a chart showing metadata stored as a CSV file;

FIG. 6 is a flow chart showing the internal processing of the mobile terminal 10;

FIGS. 7A and 7B are views showing a case where a cursor moves in response to an operation;

FIGS. 8A to 8D are views of screen transition for explaining rewriting of UI metadata;

FIGS. 9A to 9C are charts for explaining rewriting of UI metadata;

FIG. 10 is a flow chart showing the operation when UI operation is performed in the mobile terminal 10;

FIG. 11 is a flow chart showing the details of processing supporting rich content in a relay server 20; and

FIG. 12 is a diagram showing an example of transition of the display of a piece of rich content.

### DETAILED DESCRIPTION OF THE PREFERRED EMBODIMENTS

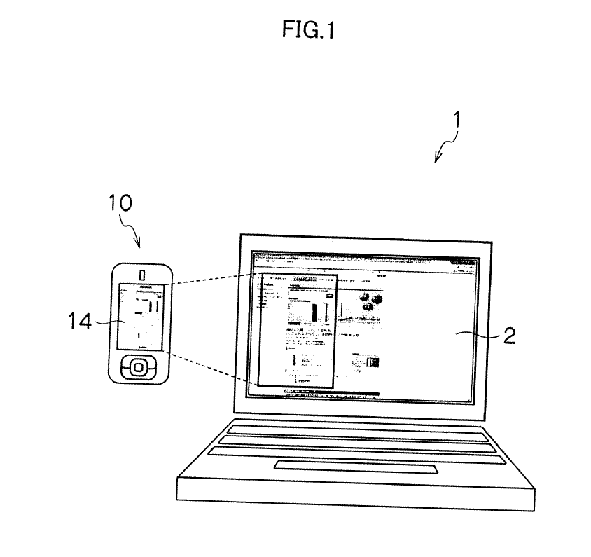

FIG. 1 is a view showing how a Web page is browsed with a display unit 14 of a mobile terminal 10 in the same manner as when the Web page is browsed with a display unit 2 of a PC 1. As shown in FIG. 1, the mobile terminal (mobile phone) 10 can browse a Web page, like PCs.

An embodiment of the present invention will be described below with reference to the accompanying drawings.

### Embodiment

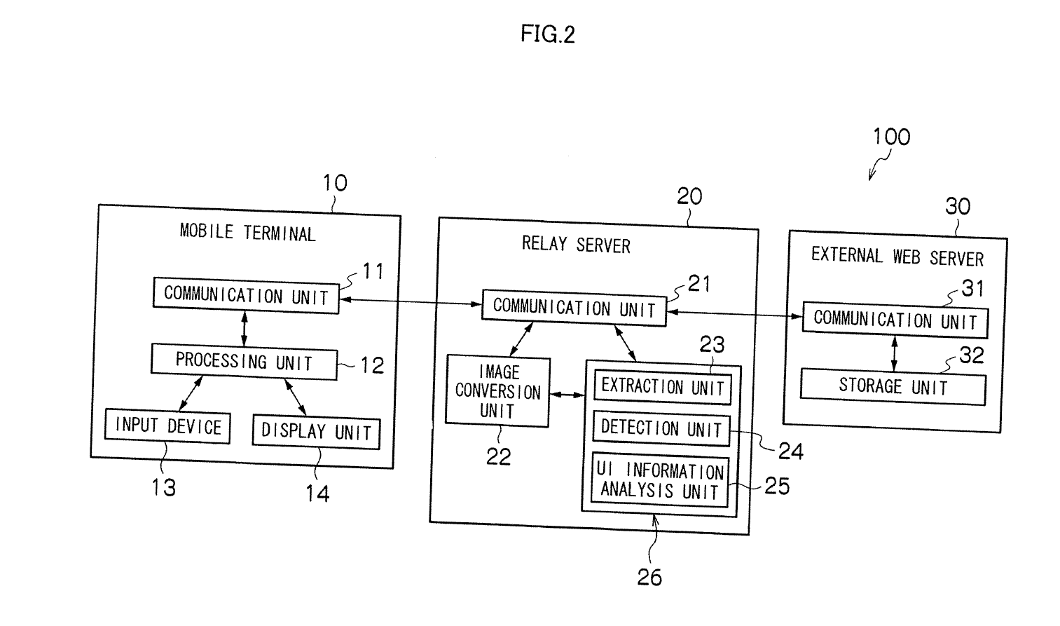

FIG. 2 is a diagram showing an example of the overall configuration of a Web page browsing system 100 according to this embodiment. As shown in FIG. 2, the Web page browsing system 100 is composed of a mobile terminal 10 which is used by a user, an external Web server 30, and a relay server 20 which relays communication between the mobile terminal 10 and the external Web server 30. Note that the system implements a full browser in the mobile terminal 10 but is a thin-client system in which the relay server 20 takes charge of most of processes.

The mobile terminal 10 includes a communication unit 11, a processing unit 12, an input device 13, and a display unit 14 and is composed of an ordinary mobile phone or the like.

The communication unit 11 controls communication with the relay server 20 via a predetermined protocol.

The mobile terminal 10 and the relay server 20 are connected over the so-called Internet. The communication unit 11 and a communication unit 21 (to be described later) communicate with each other according to a standard Internet protocol such as TCP/IP. Note that the mobile terminal 10 and the relay server 20 may be connected via a dedicated communication line or over a VPN.

The processing unit 12 displays an image which is acquired from the relay server 20 via the communication unit 11 on the display unit 14 and performs a process corresponding to an input operation performed with the input device 13 by a user.

The input device 13 includes a power button, numeric keys, a cross key, and an Enter key (not shown). A user can control the mobile terminal 10 by operating the input device 13. A touch panel may be disposed on the front of the display unit 14 for use as the input device 13.

The display unit 14 is a liquid crystal display capable of color display and produces a display on the basis of image signals inputted from the processing unit 12. Note that any other type of display device such as an organic EL may be used instead of the LCD.

The relay server 20 includes the communication unit 21, an image conversion unit 22, and a processing unit 26 having an extraction unit 23 which extracts a rich content area, a detection unit 24 which detects a change in rich content, and a user interface (UI) information analysis unit 25.

The communication unit 21 controls both communication with the mobile terminal 10 and communication with the external Web server 30. The relay server 20 and the external Web server 30 are connected to each other over the Internet. The communication unit 21 and a communication unit 31 (to be described later) communicate with each other according to a standard Internet protocol.

The image conversion unit 22 generates an image file equivalent to a state in which a Web page acquired from the external Web server 30 via the communication unit 21 is browsed on the basis of the Web page. Although an image file of a predetermined resolution is generated here, an image file of a resolution corresponding to the content of the Web page and the resolution of the mobile terminal 10 may be generated instead.

The extraction unit 23 extracts an area on a Web page where a piece of rich content is located (a rich content area) when the Web page incorporates the piece of rich content. A tag for a piece of rich content (a Flash tag if, for example, the piece of rich content is a piece of Flash content) is described in the HTML file of a Web page. A rich content area is extracted by reading a display location and a display size from a Flash tag.

The detection unit 24 is a unit which acquires an image in a rich content area at fixed time intervals and detects a change in a piece of rich content on the basis of each two acquired images that are temporally continuous.

The UI information analysis unit 25 extracts pieces of UI information from content files of an acquired Web page, analyzes the type and position of each piece of UI information, and generates UI metadata.

The external Web server 30 includes the communication unit 31 and a storage unit 32.

The communication unit 31 controls communication with the relay server 20. The storage unit 32 stores content files of a Web page established in the external Web server 30. The communication unit 31 reads, from the storage unit 32, files corresponding to a request with a URL received from the relay server 20 and transmits the files to the relay server 20.

Note that although the number of mobile terminals 10 shown in FIG. 2 is only one, the mobile terminals 10 capable of communication with the relay server 20 are present in large numbers and communicate with the relay server 20 separately. Additionally, the external Web servers 30 are present in large numbers in the Internet, and the relay server 20 can communicate with each external Web server 30. As described above, communication via the relay server 20 is performed regardless of which mobile terminal 10 accesses which external Web server 30.

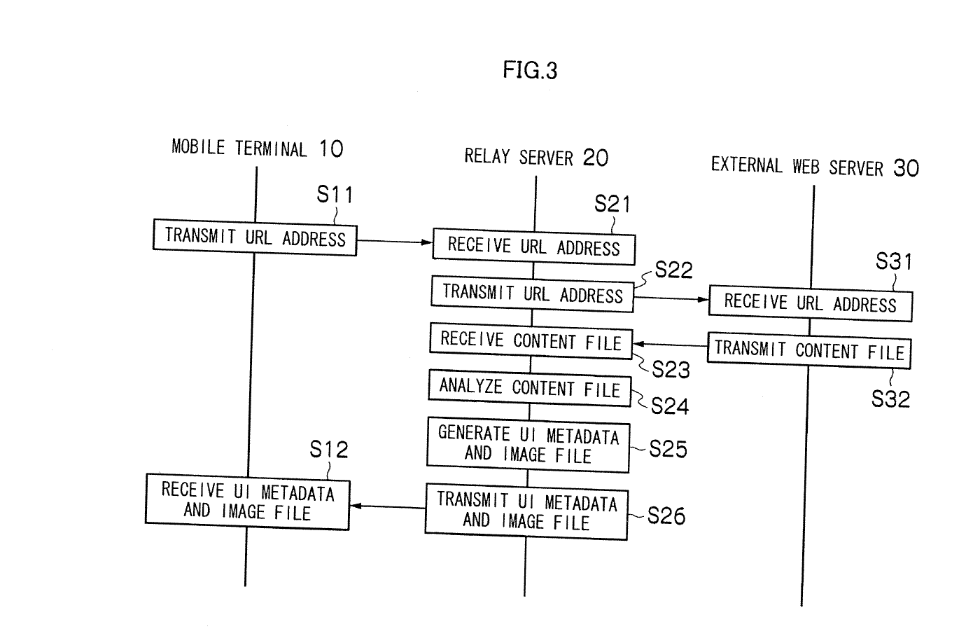

The operation of the Web page browsing system 100 with the above-described configuration will be described. The operation until a desired Web page is displayed on the display unit 14 of one of the mobile terminals 10 will be described with reference to FIG. 3.

A user enters the URL address of a Web page desired to be browsed with the input device 13 of the mobile terminal 10. Instead of directly entering a character string, a URL address may be selected by using, e.g., a bookmark registered in a storage unit (not shown) of the mobile terminal 10. When instructions for transmission are given through a Send button of the input device 13 after the URL address is entered, the communication unit 11 transmits the entered URL address to the relay server 20 (step S11).

Note that pairs of a Web page title and a URL address may be held in the bookmark of the storage unit (not shown) of the relay server 20 and that one may be selected from among the Web page titles. In this case, the relay server 20 transmits the held Web page titles to the mobile terminal 10 via the communication unit 21, and the mobile terminal 10 receives the Web page titles via the communication unit 11. The processing unit 12 displays the received Web page titles on the display unit 14. The user selects, with the input device 13, one corresponding to the desired Web page from among the displayed Web page titles. The mobile terminal 10 may transmit the selected Web page title to the relay server 20 via the communication unit 11.

The relay server 20 receives, via the communication unit 21, the URL address transmitted from the mobile terminal 10 (step S21). The communication unit 21 transmits the received URL address to one of the external Web servers 30 which corresponds to the URL address (step S22). If one of the Web page titles is selected by using the bookmark of the relay server 20, a URL address corresponding to the Web page title may be read from the storage unit (not shown), and the URL address may be transmitted to one of the external Web servers 30 which corresponds to the URL address.

The corresponding external Web server 30 receives the URL address via the communication unit 31 (step S31). The external Web server 30 reads, from the storage unit 32, content files such as an HTML file, a CSS file, and a JavaScript (Java is a registered trademark) file corresponding to the received URL address and transmits the content files to the relay server 20 via the communication unit 31 (step S32).

The relay server 20 receives the content files transmitted from the external Web server 30 (step S23) and analyzes the received content files and extracts a piece of UI information with the UI information analysis unit 25 (step S24). A method for analyzing content files used here is not particularly limited, and a known method such as the process of parsing content files and extracting tags may be used.

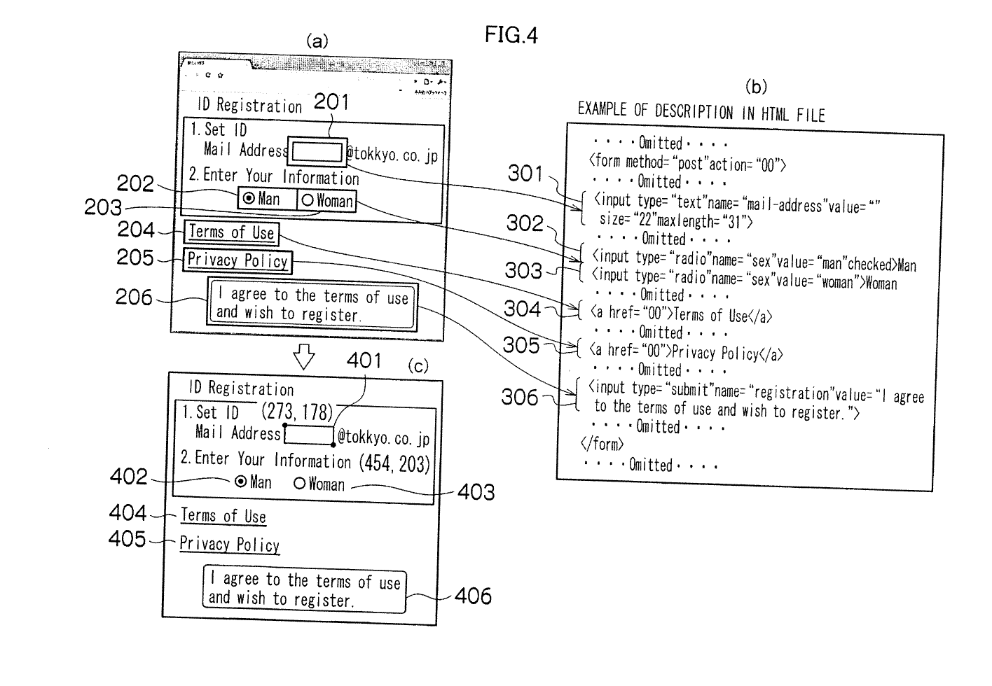

The UI information analysis unit 25 generates UI metadata on the basis of a result of the analysis (step S25). FIG. 4 is a view for explaining generation of UI metadata. (a) portion of FIG. 4 is a view showing a state in which the HTML file shown in (b) portion of FIG. 4 is browsed with an ordinary PC or the like. Note that unnecessary parts have been appropriately omitted in the HTML file shown in (b) portion of FIG. 4.

The UI information analysis unit 25 extracts pieces of UI information such as a link tag and an entry form from the HTML file shown in (b) portion of FIG. 4 and calculates the position coordinates of each piece of UI information in (a) portion of FIG. 4.

For example, six tags of a text entry field tag 301, a radio button tag 302, a radio button tag 303, a link tag 304, a link tag 305, and a button tag 306 are described in the HTML file shown in (b) portion of FIG. 4. The UI information analysis unit 25 extracts the tags from the HTML file, thereby extracting pieces 201 to 206 of UI information.

The pieces 201 to 206 of UI information are arranged at the positions on the screen shown in (a) portion of FIG. 4 when the HTML file is browsed. The UI information analysis unit 25 acquires the start and end X and Y coordinate values (the coordinate values of the upper left and lower right corners) of each of the pieces of UI information. A method for acquiring coordinate values is not particularly limited. For example, the process of storing coordinate values during image rendering or the process of acquiring coordinate values from a browser may be used.

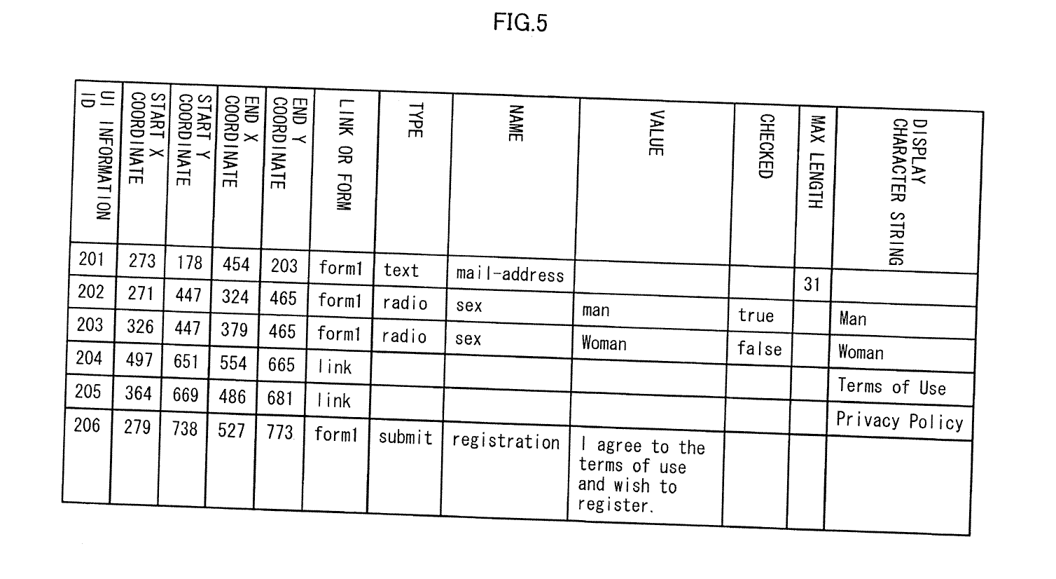

Each piece of UI information extracted in the above-described manner and the pieces of information on the position of the piece of UI information are associated with a corresponding UI information ID, and the sets of associated pieces of information are stored as UI metadata in the storage unit (not shown) of the relay server 20. In this embodiment, the UI information IDs of the pieces of UI information are 201 to 206, respectively. FIG. 5 is a chart showing UI metadata stored as a CSV file. UI metadata need not include attributes (e.g., the size attribute) related to screen display such as a layout.

The image conversion unit 22 renders the acquired content files and generates an image file in a format displayable on the display unit 14 of the mobile terminal 10, such as the JPEG format or a bitmap format (step S25). Note that a method for generating an image file is not particularly limited and that a known method may be used.

(c) portion of FIG. 4 is a view showing an image obtained when the HTML file shown in (b) portion of FIG. 4 is rendered. Use of the UI metadata shown in FIG. 5 allows learning about the position and type of each piece of UI information in the image. For example, it can be seen that the pieces of UI information corresponding to the tags 301 to 306 are arranged at positions 401 to 406 shown in (c) portion of FIG. 4. The arrangement is similar to the arrangement of the pieces 201 to 206 of UI information in the browsed state shown in (a) portion of FIG. 4. The image file may be stored in the storage unit (not shown) of the relay server 20 together with the UI metadata.

The relay server 20 transmits the UI metadata and image file generated in step S25 to the mobile terminal 10 via the communication unit 21 (step S26). At this time, the relay server 20 associates the content files serving as the base of the UI metadata and image file with the destination mobile terminal 10 and the generated UI metadata and stores the pieces of data in the storage unit (not shown). The mobile terminal 10 receives the UI metadata and image file via the communication unit 11 (step S12).

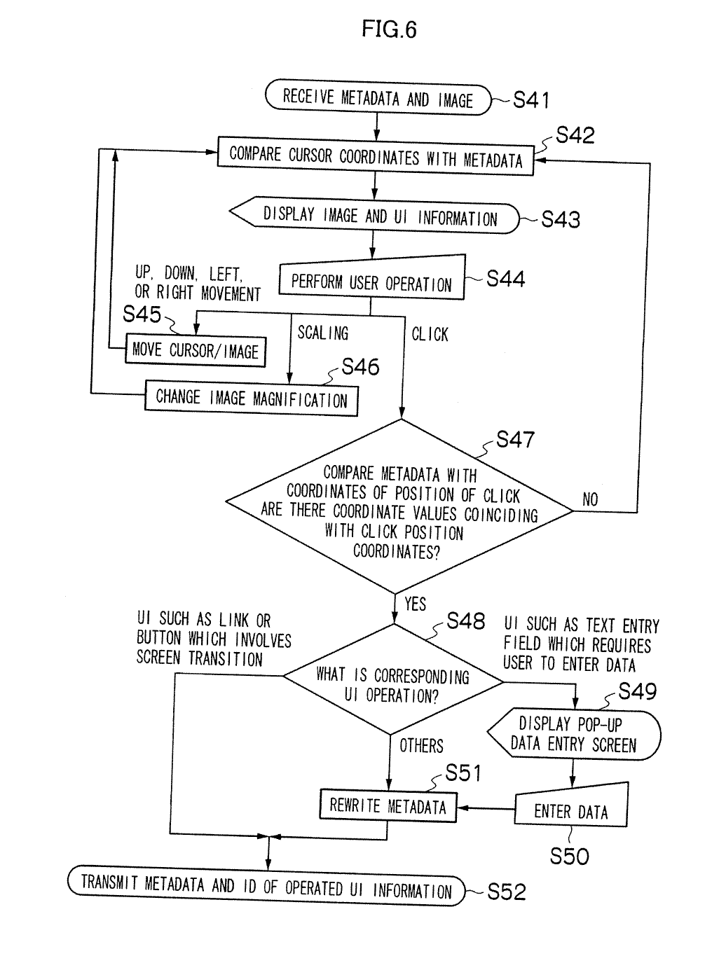

The internal processing of the mobile terminal 10 after receipt of the UI metadata and image file will be described with reference to FIG. 6.

When the mobile terminal 10 receives the UI metadata and image file via the communication unit 11 (step S41), the processing unit 12 compares the position coordinates of each piece of UI information included in the received UI metadata with the position coordinates of a cursor displayed on the display unit 14 (step S42) and displays the image file and pieces of UI information on the basis of a result of the comparison on the display 14 (step S43).

For example, if the position coordinates of the cursor coincide with the position coordinates of one of the pieces of UI information, a mark is placed at the piece of UI information to cause a user to recognize that the piece of UI information can be selected. The piece of UI information may be underlined or enclosed in a box instead. Note that the position coordinates of each piece of UI information in the UI metadata are regarded as coinciding with the position coordinates of the cursor when the cursor is located within a rectangular area whose opposing corners have the same X and Y coordinate values as those of the piece of UI information. Such a mark may be always displayed at each displayed piece of UI information on the image instead of being displayed when the position coordinates of the cursor coincides with those of the piece of UI information. Alternatively, when the position coordinates of the cursor coincide with those of the piece of UI information, the color and shape of the displayed cursor may be changed.

When a user operation is performed with the input device 13 (step S44), the processing unit 12 changes the display on the display unit 14 in response to the operation.

For example, when an up, down, left, or right movement operation is performed with the cross key or the like, the processing unit 12 moves the cursor or the image in response to the operation (step S45).

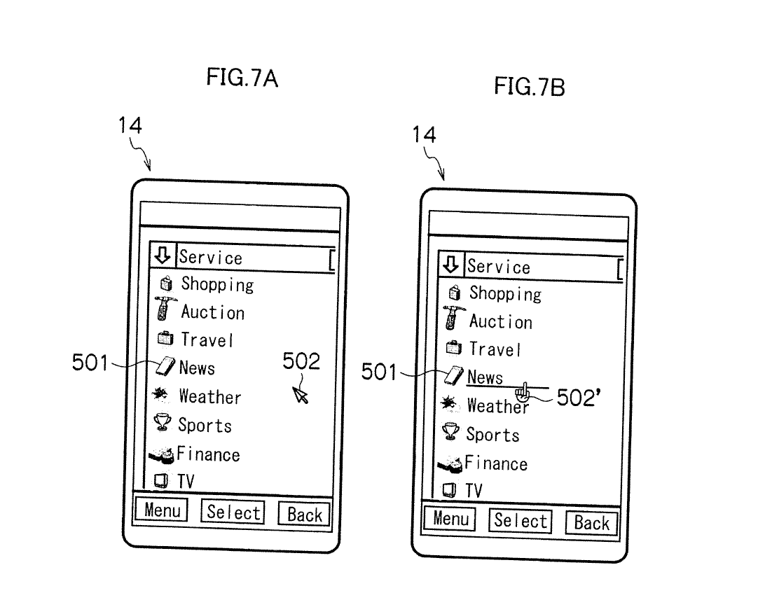

FIGS. 7A and 7B are views showing a case where a cursor moves in response to an operation. FIG. 7B shows the display after an upper left movement operation is performed in the state of FIG. 7A. When a cursor 502 is moved onto a position 501 (where a link is placed) of the piece of UI information above and on the left of the cursor 502 on the screen in response to a user operation, a line is drawn under the position 501 of the piece of UI information, and the cursor 502 is changed into a cursor 502′.

Note that an operation of the Enter button in this state allows display of a linked page associated with the position 501 of the piece of UI information, as will be described later.

When a scaling operation is performed in step S44, the processing unit 12 displays the image again at a magnification changed in response to the operation (step S46).

When an operation (a click operation) using the Enter button is performed in step S44, the processing unit 12 determines, on the basis of a result of the comparison in step S42, whether the position of the cursor coincides with the positions on the image of the pieces of UI information (step S47).

If the cursor position does not coincide with the positions on the image of the pieces of UI information, the processing unit 12 ignores the click operation and returns to step S42 to perform similar processing.

If the cursor position coincides with the position on the image of one of the pieces of UI information, the processing unit 12 determines the type of the piece of UI information present at the position coinciding with the cursor position, on the basis of the UI metadata (step S48).

There are three possible types of UI information: (1) a piece of UI information such as a text entry field which requires a user to make an entry; (2) a piece of UI information such as a checkbox or a radio button which does not involve screen transition and does not require data entry: and (3) a piece of UI information such as a link or a button which involves screen transition.

In the case (1) where the piece of UI information present at the position of the cursor is a piece of UI information such as a text entry field which requires a user to enter data, the processing unit 12 first displays a data entry screen on the display unit 14 in, e.g., a pop-up manner and requests a user to make an entry (step S49). The user enters necessary data on the entry screen with the input device 13 (step S50). The processing unit 12 rewrites the UI metadata stored in the storage unit (not shown) in response to the user input (step S51). The rewritten UI metadata is transmitted to the relay server 20 via the communication unit 11 together with the ID of the rewritten piece of UI information (step S52).

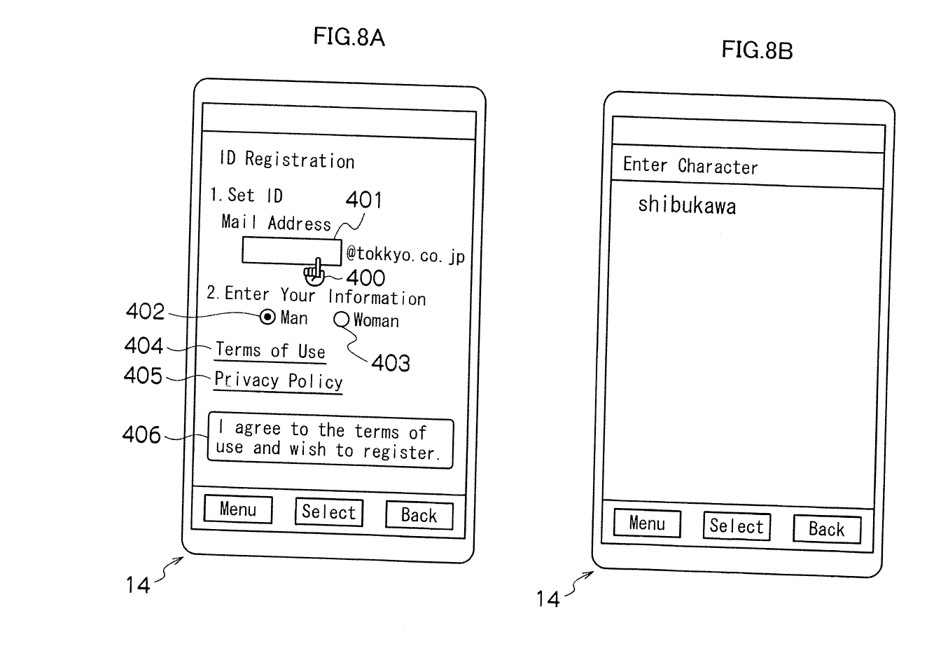

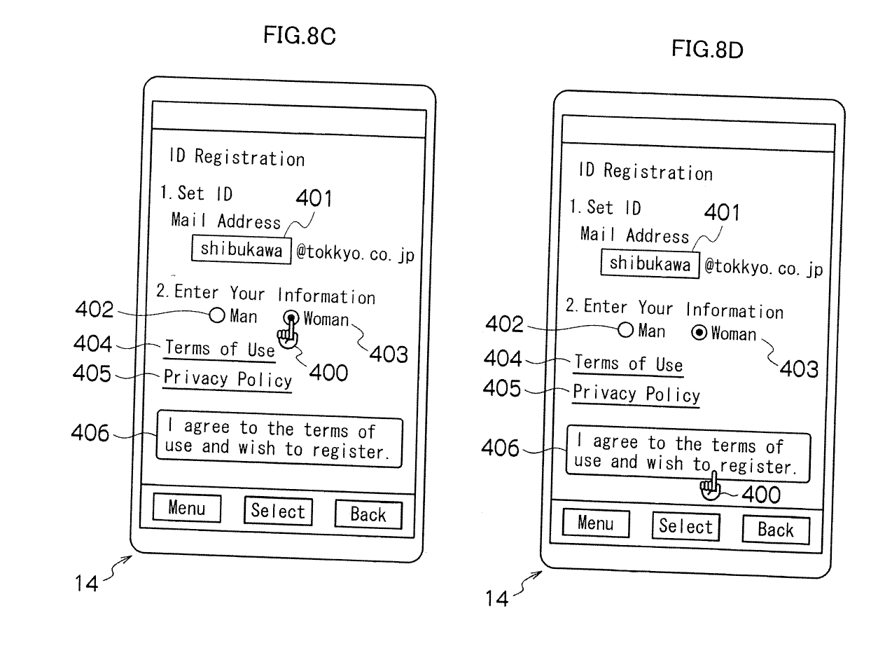

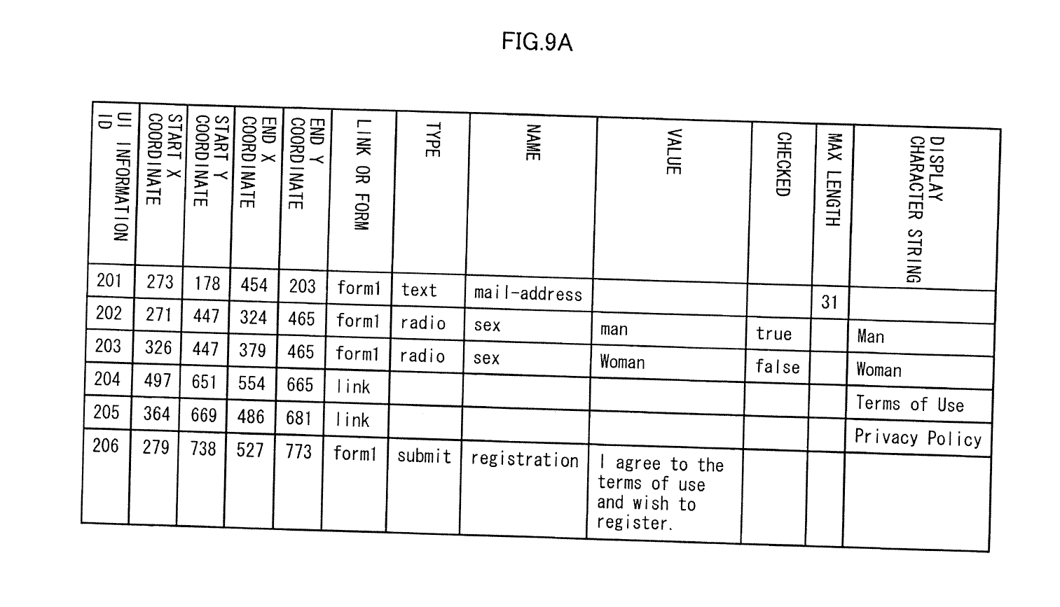

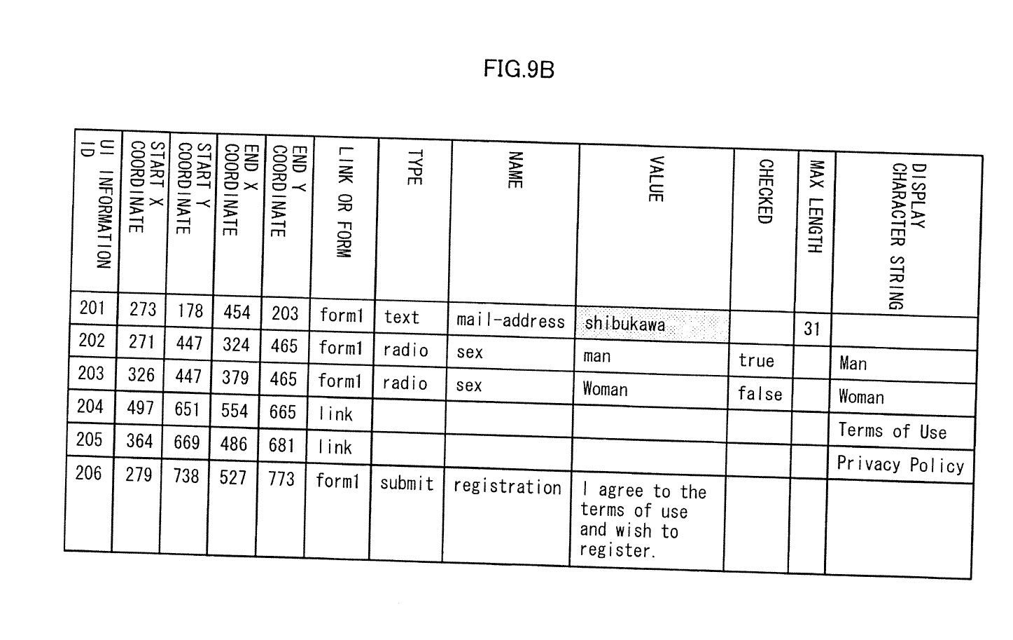

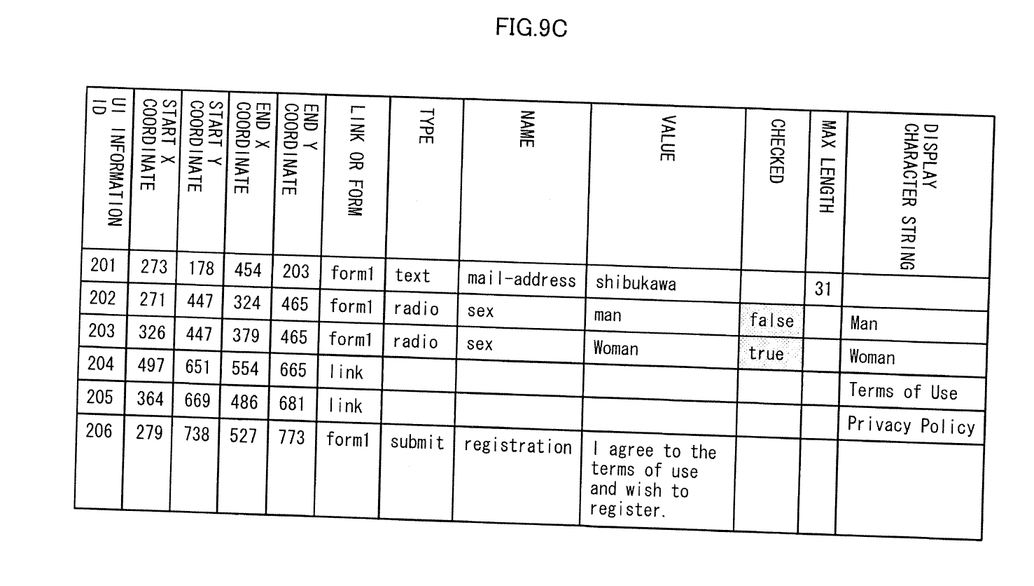

The details of rewriting of UI metadata will be described with reference to FIGS. 8A to 8D and 9A to 9C.

FIG. 8A is a view showing how the image shown in (c) portion of FIG. 4 is displayed on the display unit 14. The pieces 201 to 206 of UI information are displayed at the positions 401 to 406 on the displayed image, as can be seen from the UI metadata shown in FIG. 9A. When a user moves a cursor 400 onto the position 401 corresponding to the piece 201 of UI information and performs a click operation, a text entry pop-up screen is displayed on the display unit 14, as shown in FIG. 8B.

The user enters a desired character on the pop-up screen with the input device 13. When the user performs a click operation with the input device 13 after entering text, the processing unit 12 rewrites the value attribute of the piece 201 of UI information corresponding to the position 401 on the basis of the entered text. The user has entered “shibukawa” on the text entry pop-up screen in this example, as shown in FIG. 8B. Accordingly, the value attribute of the piece 201 of UI information has been changed to “shibukawa,” as shown in FIG. 9B.

The rewritten UI metadata is transmitted to the relay server 20 via the communication unit 11 together with the ID (201 in this example) of the rewritten (operated) piece of UI information.

The case (2) where the piece of UI information in question does not involve screen transition and does not require data entry will be described.

Radio buttons for specifying sex are displayed at the position 402 corresponding to the piece 202 of UI information and the position 403 corresponding to the piece 203 of UI information shown in FIG. 8C. As shown in FIG. 4, the tags 302 and 303, on which the pieces 202 and 203 of UI information are based, have the same name attributes. That is, either one of the pieces 202 and 203 of UI information can be selected. By default, the checked attribute of the piece 202 of UI information is true, and the checked attribute of the piece 203 of UI information is false, as shown in FIG. 9A. The piece 202 of UI information is thus in selected status, as shown in FIG. 8A.

When the cursor 400 is moved onto the position 403 corresponding to the piece 203 of UI information, and a click operation is performed, the processing unit 12 determines the type of the piece of UI information present at the position coinciding with the position of the cursor, on the basis of the UI metadata.

Since the piece 203 of UI information is a radio button and is a piece of UI information which does not require a user to enter data and does not involve screen transition, the processing unit 12 shifts to step S51. The processing unit 12 rewrites a piece of data on the piece 203 of UI information of the UI metadata stored in the storage unit (not shown).

FIG. 9C is a chart showing the rewritten UI metadata. As shown in FIG. 9C, the checked attribute of the piece 203 of UI information has been changed to true, and the checked attribute of the piece 202 of UI information, which has the same name attribute as that of the piece 203 of UI information, has been changed to false.

Finally, the case (3) where the piece of UI information in question involves screen transition will be described. A piece of UI information which involves screen transition refers to a piece of UI information which causes an image different from the currently displayed image to be displayed after the piece of UI information is operated.

As shown in FIG. 8D, a submit button is displayed at the position 406 corresponding to the piece 206 of UI information. A click operation on the position 406 causes the screen to transition to another screen according to the description of the tag 306. When the cursor 400 is moved onto the position 406, and a click operation is performed, the processing unit 12 determines the type of the piece of UI information present at the position coinciding with the position of the cursor, on the basis of the UI metadata.

Since the piece 206 of UI information is a button and is a piece of UI information which involves screen transition, the processing unit 12 shifts to step S52. The ID (206 in this example) of the operated piece of UI information is transmitted to the relay server 20 via the communication unit 11 together with the UI metadata (step S52).

As described above, whichever type of UI information is clicked, the UI metadata and the ID of the operated piece of UI information are transmitted to the relay server 20.

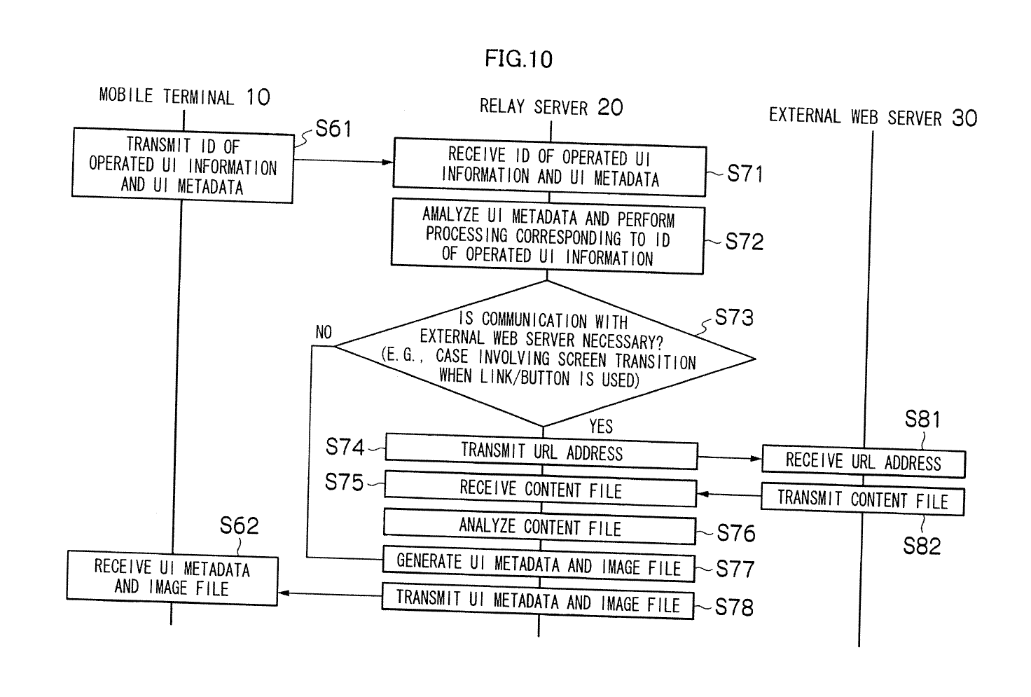

The operation of the Web page browsing system 100 based on UI metadata after a click operation is performed will be described with reference to FIG. 10.

In FIG. 10, when UI metadata and the ID of an operated piece of UI information are transmitted from the mobile terminal 10 (step S61), the relay server 20 receives the pieces of data via the communication unit 21 (step S71).

The UI information analysis unit 25 analyzes the received UI metadata and the ID of the operated piece of UI information and analyzes which piece of UI information of the UI metadata has been operated (step S72).

The UI information analysis unit 25 also determines, on the basis of the operated piece of UI information, whether communication with an external Web server is necessary (step S73). Communication with an external Web server is necessary, for example, when a link button is operated, and screen transition is to be performed.

If the operated piece of UI information is a piece of UI information which requires communication with an external Web server, the relay server 20 acquires the URL address of a transition destination from content files stored in the storage unit (not shown) and transmits the URL address to a corresponding one of the external Web servers 30 (step S74). The relay server 20 receives corresponding content files from the external Web server 30 (step S75). The UI information analysis unit 25 analyzes the content files of the transition destination (step S76).

The UI information analysis unit 25 generates UI metadata for the transition destination on the basis of a result of the analysis, and the image conversion unit 22 generates an image file on the basis of the content files on the basis of the transition destination (step S77). The relay server 20 transmits the image file and UI metadata of the transition destination to the mobile terminal 10 via the communication unit 21 (step S78).

The mobile terminal 10 receives the image file and UI metadata via the communication unit 11 and displays the image file as a transition destination screen on the display unit 14 (step S62).

If it is determined in step S73 that the operated piece of UI information is a piece of UI information which does not require communication with an external Web server, the flow shifts to step S77. The relay server 20 reads the content files associated with the rewritten UI metadata from the storage unit (not shown) and generates a new image file on the basis of the rewritten UI metadata. Instead of generating a new image file, only a part which requires rewriting due to the operation of an original image generated from the content files may be rewritten on the basis of the image and the ID of the operated piece of UI information.

The relay server 20 transmits the new image file and UI metadata to the mobile terminal 10 via the communication unit 21 (step S78).

The mobile terminal 10 receives the image file and UI metadata via the communication unit 11 and displays the image file on the display unit 14 (step S62).

For example, if the operated piece of UI information is a piece of UI information (a text entry field) at the position 401 shown in FIG. 8A, the rewritten UI metadata shown in FIG. 9B and the ID of 201 of the operated piece of UI information are transmitted from the mobile terminal 10 (step S61). The relay server 20 receives the pieces of data via the communication unit 21 (step S71).

The image conversion unit 22 reads the content files associated with the rewritten UI metadata from the storage unit (not shown) and generates a new image file on the basis of the rewritten UI metadata. The new image file is an image in which the character string “shibukawa” entered in step S50 is displayed at the text entry field, as shown in FIG. 8C.

If the operated piece of UI information is a piece of UI information (a radio button) at the position 403 shown in FIG. 8C, the rewritten UI metadata shown in FIG. 9C and the ID of 203 of the operated piece of UI information are transmitted from the mobile terminal 10 (step S61). The relay server 20 receives the pieces of information via the communication unit 21 (step S71).

The image conversion unit 22 reads the content files associated with the rewritten UI metadata from the storage unit (not shown) and generates a new image file on the basis of the rewritten UI metadata. The new image file is an image in which a checked radio button position has been changed from the position 402 to the position 403, as shown in FIG. 8D.

If the operated piece of UI information is a piece of UI information (a button) at the position 406 shown in FIG. 8D, the UI metadata (not rewritten in this case) and the ID of 206 of the operated piece of UI information are transmitted from the mobile terminal 10 (step S61). The relay server 20 receives the pieces of data via the communication unit 21 (step S71).

The relay server 20 having received the pieces of data acquires the URL address of a transition destination, requests corresponding content files from a corresponding one of the external Web servers 30 (step S74), and receives the content files (step S74). On the basis of the content files, the UI information analysis unit 25 generates UI metadata, and the image conversion unit 22 generates an image file (step S77).

The image file and UI metadata of the transition destination are transmitted to the mobile terminal 10 (step S78), and the image file is displayed on the display unit 14 (step S62).

As described above, even if a UI operation involving screen transition is performed, a new Web page as a transition destination can be displayed, and pieces of UI information can be operated as heretofore.

As has been described above, the Web page browsing system 100 can implement high-speed, user-friendly Web page browsing.

[Support of Rich Content]

Some Web pages incorporate a piece of rich content. Support of rich content will be described below.

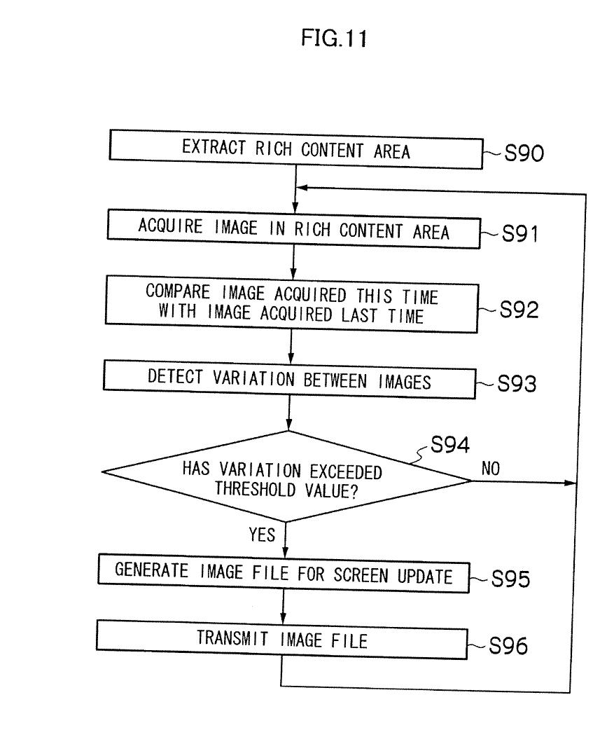

FIG. 11 is a flow chart showing the details of processing supporting rich content in the relay server 20. FIG. 11 shows processes subsequent to the process in step S26 (the transmission of the UI metadata and the image file to the mobile terminal 10) shown in FIG. 3.

In FIG. 11, the extraction unit 23 of the relay server 20 extracts a rich content area (step S90) if the Web page incorporates a piece of rich content. The detection unit 24 captures an image from the extracted rich content area at fixed time intervals and determines whether the captured image has changed (steps S91, S92, S93, and S94).

The detection unit 24 includes an image acquisition unit which continuously captures an image from a rich content area at fixed time intervals, a variation detection unit which compares two temporally continuous images that are continuously acquired (an image acquired this time and an image acquired last time) and detects a variation between the images, and a determination unit which determines a change in a piece of rich content on the basis of a detected variation.

The image acquisition unit continuously captures an image from the rich content area at the fixed time intervals (step S91). The variation detection unit compares an image acquired this time with an image acquired last time (an immediately preceding image) (step S92) and detects a variation between the images (step S93).

In steps S92 and S93, when the variation detection unit receives the image acquired by the image acquisition unit, the variation detection unit performs the process of reducing the received image. The reduction process can be performed by thinning out pixels. The variation detection unit obtains the correlation between the image acquired this time and the image acquired last time that are reduced. The correlation can be calculated by obtaining the absolute value of the difference between the pixel values of pixels at the same positions of the two images and adding up the absolute values for all of the pixels of the two images. The accumulated value calculated in the above-described manner is an evaluation value indicating the correlation between the two images. The correlation between the two images is low when the accumulated value is large and is high when the accumulated value is small.

The determination unit determines whether the variation (the correlation value) between the two images obtained in the above-described manner has exceeded a predetermined threshold value (step S94). If the variation exceeds the threshold value (“YES”), the flow shifts to step S95. On the other hand, if the variation is not more than the threshold value (“NO”), the flow shifts to step S91.

In step S95, an image file for updating the display screen of the mobile terminal 10 is generated. The image file thus generated is transmitted from the relay server 20 to the mobile terminal 10 (step S96).

If the variation is not more than the threshold value (“NO”) in step S94 or after the image file is transmitted in step S96, the flow shifts to step S91. In step S91, an image in the rich content area is captured, and the above-described processes are repeated.

When the image file is transmitted in step S96, the mobile terminal 10 receives the image file and displays the image file on the display unit 14. With this configuration, of an image of a Web page displayed on the display unit 14 of the mobile terminal 10, an image in each rich content area remains updated.

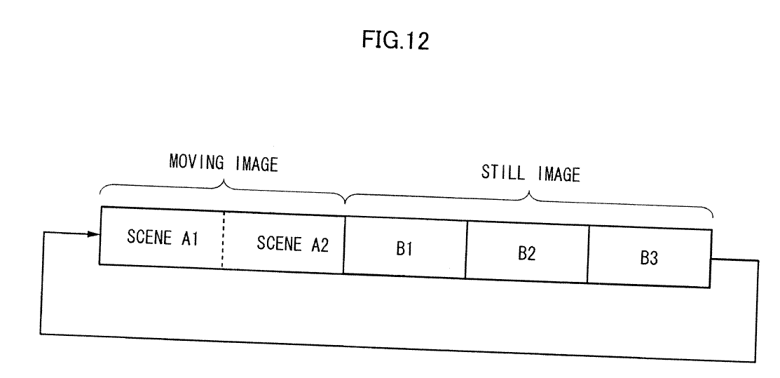

FIG. 12 shows an example of transition of the display of a piece of rich content.

The piece of rich content shown in FIG. 12 is composed of one moving image and three still images B1, B2, and B3. The piece of rich content is configured such that the moving image is displayed, the three still images B1, B2, and B3 are sequentially played back as a slide show, and the moving image is displayed again. The moving image is divided into a scene A1 and a scene A2.

When the moving image of the piece of rich content is displayed, a variation between images continuous in chronological order of the moving image in a rich content area is detected in step S93 of FIG. 11. If the set threshold value in step S94 is small or if the intervals at which an image is captured from the rich content area are relatively long, a variation between temporally continuous images is likely to be determined to have exceeded the threshold value. If it is determined that the variation between the temporally continuous images has exceeded the threshold value, an image file for a screen update is generated and is transmitted to the mobile terminal 10, as described above. An image of a Web page with an updated image in the rich content area is displayed on the mobile terminal 10. Note that, in this case, the display in the rich content area is not like the original moving image but like an animation.

On the other hand, if the set threshold value in step S94 is large or if the intervals at which an image is captured from the rich content area are relatively short, a variation between temporally continuous images within a single scene of the moving image is unlikely to be determined to have exceeded the threshold value but a variation between temporally continuous images before and after the changeover point from the scene A1 to the scene A2 is determined to have exceeded the threshold value. Accordingly, at the changeover point between the scenes of the moving image, an image file for a screen update is generated and is transmitted to the mobile terminal 10. An image of the Web page with an updated image in the rich content area is displayed on the mobile terminal 10.

If the display of the piece of rich content transitions sequentially in the order of the moving image, the still image B1, the still image B2, the still image B3, and the moving image, as shown in FIG. 12, a variation between continuous images before and after each display transition is determined to have exceeded the threshold value. Accordingly, each time the display of the piece of rich content transitions, an image file for a screen update is generated and is transmitted to the mobile terminal 10. An image of the Web page with an updated image in the rich content area is displayed on the mobile terminal 10.

In the piece of rich content shown in FIG. 12, each of the images (the moving image and the three still images B1 to B3) is associated with a URL. Accordingly, when a user clicks on one of the images in the rich content area while viewing an image of the Web page displayed on the mobile terminal 10, the relay server 20 accesses a Web server by using the URL associated with the image and causes the mobile terminal 10 to display an image of an acquired Web page.

In other words, a user can browse a Web page incorporating a piece of rich content as an image and also can browse the Web page which is updated in response to a change in the piece of rich content as an image. For this reason, when a piece of rich content displayed on the mobile terminal 10 is clicked, a Web page of a Web server corresponding to the displayed piece of rich content can be browsed.

Note that even if the newly acquired Web page corresponding to the piece of rich content is one including a text entry field which requires a user to make an entry, an input operation can be performed, as described above.

### [Others]

In the above-described embodiment, when an image in a rich content area changes by a fixed amount or more, the screen displayed on the mobile terminal 10 is updated. The present invention, however, is not limited to this. The screen displayed on the mobile terminal 10 may be updated when no change is detected for a predetermined period of time after the change of the image by the fixed amount or more (when the image transitions to a still image). According to this configuration, when a moving image is displayed in a rich content area, a screen update is not performed. A screen update can be performed when the moving image is stopped.

The relay server 20 may analyze display transitions in a piece of rich content and cause the storage device to store a predetermined image (or predetermined images) of the piece of rich content in advance. When the current image in a rich content area of a Web page coincides with the image stored in the storage device, the screen displayed on the mobile terminal 10 may be updated.

In the embodiment, the whole of an image to be displayed on the mobile terminal 10 is transmitted from the relay server 20 when the screen to be displayed on the mobile terminal 10 is updated in response to a change in a piece of rich content. The present invention, however, is not limited to this. Only an image in a rich content area and the position information of the image may be transmitted, and the mobile terminal 10 may update only an image in a corresponding rich content area with the image. This configuration allows a reduction in traffic at the time of a screen update. However, the mobile terminal 10 needs to have a function for updating only an image in a rich content area (an image synthesis function).

Rich content is not limited to Flash content. For example, a piece of content described by using a Java applet, Silverlight, or the like may be used.

The present invention is not limited to the above-described embodiments. It is, of course, understood that various modifications may be made without departing from the spirit of the present invention.

What is claimed is:

1. A Web page browsing system, comprising:
a mobile terminal capable of displaying an image, and
a relay server converting a Web page provided by a Web server into an image and providing the image to the mobile terminal,
wherein the web page browsing system allows the mobile terminal to browse a Web page, and
wherein the relay server comprises:
an extraction device which determines whether a Web page for which a browse request has been made by the mobile terminal includes a piece of rich content upon receipt of the browse request for the Web page and, if the Web page includes a piece of rich content, extracts a rich content area where the piece of rich content is displayed;
a detection device which detects a change in the piece of rich content in the extracted rich content area;
an image conversion device which converts the Web page into image data intended to be browsed on the mobile terminal in response to the browse request, the image conversion device converting the Web page into the image data intended to be browsed for a screen update when the detection device detects a change in the piece of rich content in the rich content area; and
an image data transmission device which transmits the image data intended to be browsed obtained by the image conversion device to the mobile terminal.

2. The Web page browsing system according to claim 1, wherein the detection device comprises an image acquisition device which acquires an image in the rich content area at predetermined intervals, a variation detection device which compares an image acquired this time by the image acquisition device with an image acquired last time and detects a variation between the images, and a determination device which determines, on the basis of the detected variation, that the piece of rich content has changed.

3. The Web page browsing system according to claim 2, wherein the determination device determines that the piece of rich content has changed if the variation detected by the variation detection devices exceeds a predetermined threshold value.

4. The Web page browsing system according to claim 2, wherein the determination device determines that the piece of rich content has changed when no change is detected for a predetermined period of time after the variation is detected by the variation detection device.

5. The Web page browsing system according to claim 2, wherein the variation detection device comprises a reduction device which reduces the image acquired this time by the image acquisition device and the image acquired last time and a calculation device which calculates a correlation value between the reduced images as an evaluation value indicating the variation between the images.

6. The Web page browsing system according to claim 3, wherein the variation detection device comprises a reduction device which reduces the image acquired this time by the image acquisition device and the image acquired last time and a calculation device which calculates a correlation value between the reduced images as an evaluation value indicating the variation between the images.

7. The Web page browsing system according to claim 4, wherein the variation detection device comprises a reduction device which reduces the image acquired this time by the image acquisition device and the image acquired last time and a calculation device which calculates a correlation value between the reduced images as an evaluation value indicating the variation between the images.

8. The Web page browsing system according to claim 1, wherein the detection device comprises an image acquisition device which acquires an image in the rich content area at predetermined intervals, a storage device which stores an image of the piece of rich content in the rich content area after a change, a coincidence detection device which compares the image acquired by the image acquisition device with the image stored in the storage device and detects the degree of coincidence between the images, and a determination device which determines that the piece of rich content has changed when the image in the rich content area is detected coinciding with the image stored in the storage device on the basis of the detected degree of coincidence.

9. A relay server which communicates with a mobile terminal capable of displaying an image, converts a Web page provided by a Web server into an image, and provides the image to the mobile terminal, comprising:
an extraction device which determines whether a Web page for which a browse request has been made by the mobile terminal includes a piece of rich content upon receipt of the browse request for the Web page and, if the Web page includes a piece of rich content, extracts a rich content area where the piece of rich content is displayed;
a detection device which detects a change in the piece of rich content in the extracted rich content area;
an image conversion device which converts the Web page into image data intended to be browsed on the mobile terminal in response to the browse request, the image conversion device converting the Web page into the image data intended to be browsed for a screen update when the detection device detects a change in the piece of rich content in the rich content area; and
an image data transmission device which transmits the image data intended to be browsed obtained by the image conversion device to the mobile terminal.

10. The relay server according to claim 9, wherein the detection device comprises an image acquisition device which acquires an image in the rich content area at predetermined intervals, a variation detection device which compares an image acquired this time by the image acquisition device with an image acquired last time and detects a variation between the images, and a determination device which determines, on the basis of the detected variation, that the piece of rich content has changed.

11. The relay server according to claim 10, wherein the determination device determines that the piece of rich content has changed if the variation detected by the variation detection devices exceeds a predetermined threshold value.

12. The relay server according to claim 10, wherein the determination device determines that the piece of rich content has changed when no change is detected for a predetermined period of time after the variation is detected by the variation detection device.

13. The relay server according to claim 10, wherein the variation detection device comprises an image reduction device which reduces the image acquired this time by the image acquisition device and the image acquired last time and a calculation device which calculates a correlation value between the reduced images as an evaluation value indicating the variation between the images.

14. The relay server according to claim 11, wherein the variation detection device comprises an image reduction device which reduces the image acquired this time by the image acquisition device and the image acquired last time and a calculation device which calculates a correlation value between the reduced images as an evaluation value indicating the variation between the images.

15. The relay server according to claim 12, wherein the variation detection device comprises an image reduction device which reduces the image acquired this time by the image acquisition device and the image acquired last time and a calculation device which calculates a correlation value between the reduced images as an evaluation value indicating the variation between the images.

16. The relay server according to claim 10, wherein the detection device comprises an image acquisition device which acquires an image in the rich content area at predetermined intervals, a storage device which stores an image of the piece of rich content in the rich content area after a change, a coincidence detection device which compares the image acquired by the image acquisition device with the image stored in the storage device and detects the degree of coincidence between the images, and a determination device which determines that the piece of rich content has changed when the image in the rich content area is detected coinciding with the image stored in the storage device on the basis of the detected degree of coincidence.
